(19) United States
(12) Patent Application Publication
(10) Pub. No.: US 2020/0395768 A1
(43) Pub. Date: Dec. 17, 2020

(54) Charging Station for Telecommunications Devices, Particularly for Wireless Charging Devices

(71) Applicant: Klemens Dittrich, Wuppertal (DE)

(72) Inventor: Klemens Dittrich, Wuppertal (DE)

(21) Appl. No.: 16/771,295

(22) PCT Filed: Dec. 11, 2018
(86) PCT No.: PCT/DE2018/101009

§ 371 Date: Jun. 10, 2020

(30) Foreign Application Priority Data
Dec. 11, 2017 (DE) 10 2017 129 408.2
Mar. 12, 2018 (DE) 10 2018 105 656.7

(51) Int. Cl. H02J 7/00

(52) U.S. Cl. CPC H02J 7/0044

(57) ABSTRACT

A charging station 1 for telecommunications clamps, tablet computers, small electronic devices such as clocks etc., having several webs 2-4 parallel to each other and having a platform 5, below which supply cables and connectors can be placed to connect to the appropriate charger. At least one receptacle for a charger 10, 11 is provided on the underside 6 of the platform 5.

The invention concerns a charging station for telecommunications devices, tablet computers, small electronic devices such as watches, etc., having a platform with several webs located parallel to each other, below which supply cables and connectors can be placed for connection to the appropriate charger.

Telecommunications devices such as mobile phones, tablet computers, or small devices such as electronic watches as well, are becoming increasingly popular, and several of these devices can be found in many households or offices. Every user knows the problem of often misplacing their devices or being unable to find a suitable place to charge the batteries of the devices, frequently as well because a flatmate or colleague is charging their device via the power supply. This also applies in the event that users are not at home or in the office, but in a place with which they are not familiar, for example in a hotel. Stations for holding several such portable devices are already known, for example from WO 2017/0087868, WO 2014/198262 or DE 10 2017 117 730. However, such devices are limited in their ease of use, especially since adapters are necessary to establish the connection between the device to be charged and the power supply. Since chargers that work without a cable connection, which significantly increase the flexibility in the charging process, are now familiar, it is also necessary to integrate these in a safe and effective way into a relevant charging station.

The present invention thus sets itself the task of creating a charging station for telecommunications devices, tablet computers, small electronic devices such as watches, etc., that is particularly suitable for holding several devices, including different ones, and for their installation and removal and secure connection to the power supply, in particular for wireless chargers as well.

This task is solved according to the invention in that at least one receptacle is provided for a charger on the underside of the platform.

A variety of telecommunications and small devices that are charged via a suitable charger can be arranged on the platform, which is usually integrated into a housing. Connections with or without a cable are conceivable. The chargers are placed on the underside of the platform, where receptacles for chargers are located. A charging station of this type is thus extended by a spacious area for housing chargers for wireless or wired charging. What is unique is that the chargers can also be plugged upright between the webs of the platform of the charging station, so that working with the telecommunications device etc. is possible while they are being charged via the charger.

It is recommended that the longitudinal axis of the receptacle and thus also of the chargers is arranged parallel to the webs, regardless of whether one or more receptacles are provided for the chargers on the underside of the platform. This allows the chargers to be adapted to the design of the usually rectangular platform, the chargers remain easily accessible and easy to fixture and reassemble.

As far as the placement of the receptacles on the underside of the platform is concerned, it is intended that at least two receptacles are arranged side by side on the underside of the platform, in particular if such a platform has the necessary width for accommodating two or more receptacles or chargers. In this embodiment, it is expedient if only a part of the platform has webs, so that the webs do not extend from face to face, so that there is space on the other side of the webs or on the opposite side of the platform for the placement of the wireless chargers in an inner housing positioned there.

According to an alternative, at least two receptacles are arranged in series on the underside of the platform. Accommodating the chargers in this way is expedient above all if the charging station is narrow and thus there is space for receptacles or chargers. With this solution, too, it is recommended that the webs only extend over part of the platform to make room for the chargers.

Another advantageous embodiment of the invention provides that a recess on the underside of the platform into which the charger can be inserted from below, or inserted from the side, serves as a receptacle for the charger. The receptacle formed as a recess and the charger are correspondingly designed and dimensioned to each other. Placing the charger is therefore particularly easy to handle, especially since users can see immediately that the charger must be inserted into the receptacle.

In a variant of the invention, the fact that the platform has an opening on its face for inserting or sliding the charger into the recess simplifies the assembly and disassembly of the charger. At the same time, thanks to the lateral insertion mechanism, it is ensured that the charger cannot fall out of the recess. The dimensions of the recess correspond appropriately to the dimensions of the charger.

It is also recommended that the recess on the underside of the platform has a fastening for the charger, which additionally ensures that the charger cannot slip or fall out of the recess. This measure is of course particularly useful from the point of view that the chargers are planned for the underside of the platform, which is particularly useful in the design without a lateral insertion mechanism.

In this sense, the proposal is that the charger is fastened with at least one bracket, which is also assigned to the corresponding receptacle and fixes the charger at its position in the receptacle on the underside of the platform.

An alternative to such a bracket provides that several clamps, preferably four, into or below which the charger is inserted so to speak sideways, serve as fasteners for the charger. The clamps are attached on the underside of the platform. The clamps are conveniently provided in the corner area of the chargers for installation.

If the platform has a both a recess and a receptacle for chargers, a type of combination is created between the two previously provided alternatives, on the one hand a recess for inserting a charger and, on the other hand, a receptacle with preferably four clamps for inserting the charger into the receptacle.

Another advantageous embodiment of the invention provides that adapters are positioned on the underside of the platform namely between the webs in the area of the receptacles for devices. The devices are inserted into these spaces, which serve as receptacles, and then rest on the bottom of the space or on the adapters, so that the cross-section of such a receptacle can affect which, how and how many devices can be positioned in it. The adapters themselves are also used to establish the connection between the top and bottom of the platform and/or to run the charging cables through.

In this sense, the proposal is understood whereby the adapters partially penetrate the receptacles on their underside and thus serve as a direct support for the devices. In particular, it is planned to provide two adapters side by side on the same space.

This technology is particularly advantageous for wireless chargers that are in contact during the charging process with the smartphones or other devices to be charged. For this purpose, the charger and the device to be charged are inserted together and, if necessary, one after the other in one of the gaps. Because there is an inclined surface integrated into the adapter, preferably at its top and/or underside, the smartphone can be simply leaned on the charger—or the other way round—so that both devices are also secured in relation to each other against slipping out of the gaps between the webs or tilting.

As far as the adapter is concerned, it is provided that the adapter has an upper housing part and a lower housing part, whereby both housing parts are connected to each other, preferably in the framework of a snaplock connection.

The invention is characterised in particular by the fact that a charging station is created for telecommunications devices, tablet computers, small electronic devices such as watches etc., that is characterised by special flexibility in the use of different chargers. A charging station according to the invention is extended by ample space for wireless charging. This makes the charging station into a wireless charging station. A wireless charger is simply inserted into the receptacle positioned on the underside of the platform or, in a complementary or alternative embodiment, inserted from the face or longitudinal side and fastened by one or more brackets if necessary. Depending on the size of the charging station, one or two chargers can be mounted side by side or in series without affecting the charging of other devices. According to an alternative solution, there are two or more clip-type clamps on the underside of the platform, under which the wireless charger can be slid. This means that users can decide whether they want to charge their devices with cables or without. A charger of this type can also be inserted vertically into the platform so that it be used and charged at the same time.

Further details and advantages of the subject-matter of the invention can be found in the following description of the corresponding drawing, in which a preferred embodiment with the necessary details and individual parts is shown. The following can be seen:

FIG. 1 shows a platform in perspective,

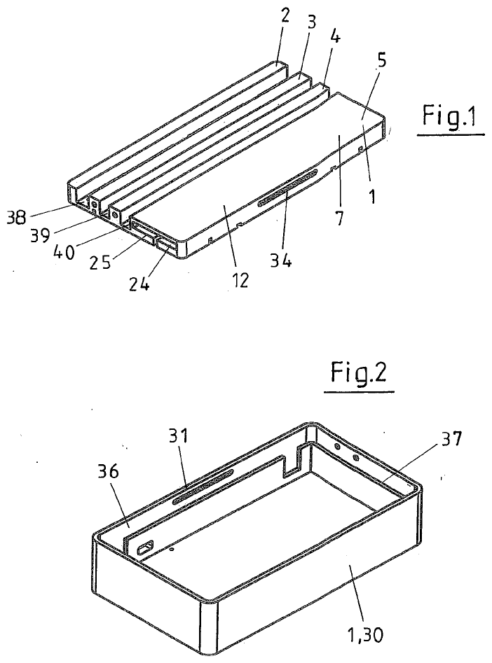

FIG. 2 shows a housing in perspective,

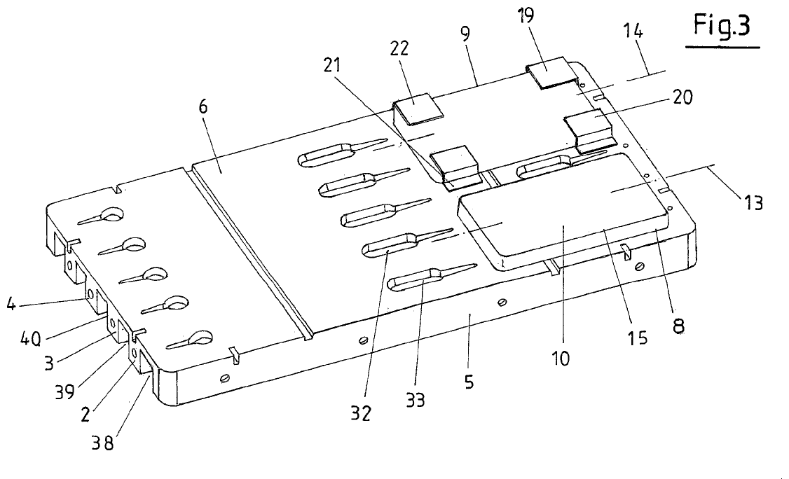

FIG. 3 shows a platform with chargers seen diagonally from below,

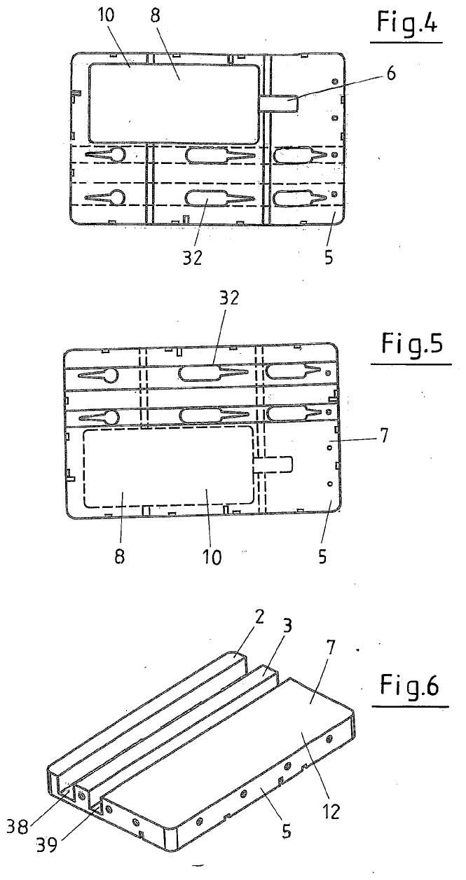

FIG. 4 shows a platform seen from below,

FIG. 5 shows a platform seen from above,

FIG. 6 shows a platform in perspective,

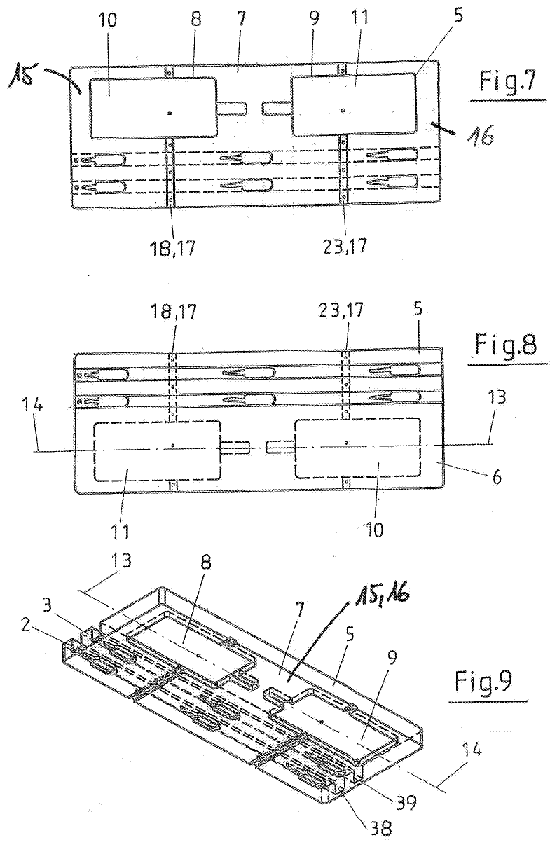

FIG. 7 shows a variant of FIG. 4,

FIG. 8 shows a variant of FIG. 5,

FIG. 9 shows a variant of FIG. 6,

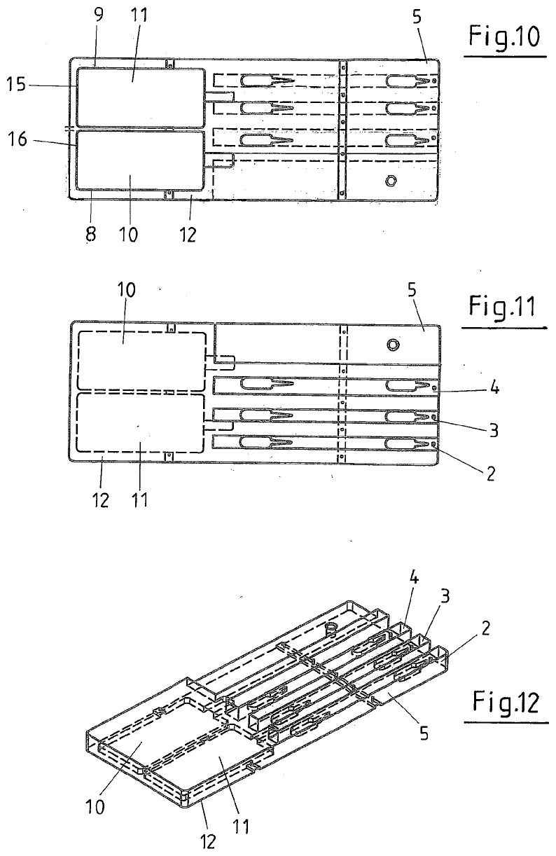

FIG. 10 shows a variant of FIG. 4,

FIG. 11 shows a variant of FIG. 5,

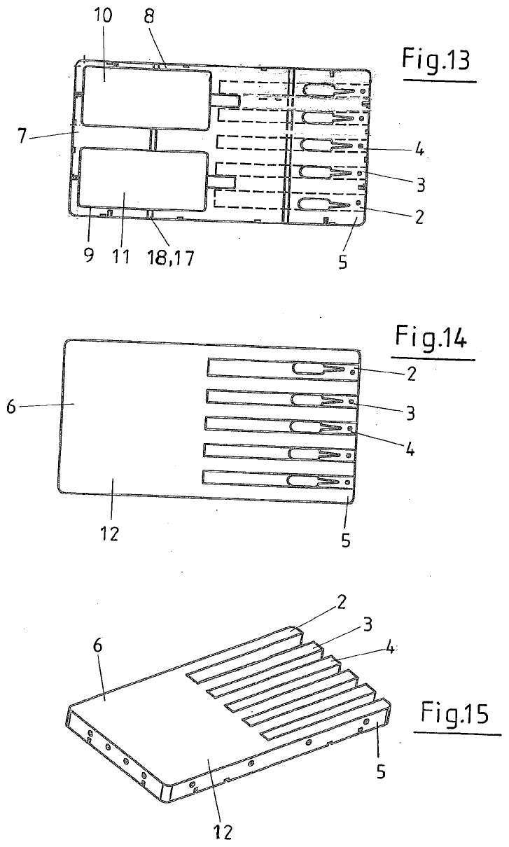

FIG. 12 shows a variant of FIG. 6,

FIG. 13 shows a variant of FIG. 4,

FIG. 14 shows a variant of FIG. 5,

FIG. 15 shows a variant of FIG. 6,

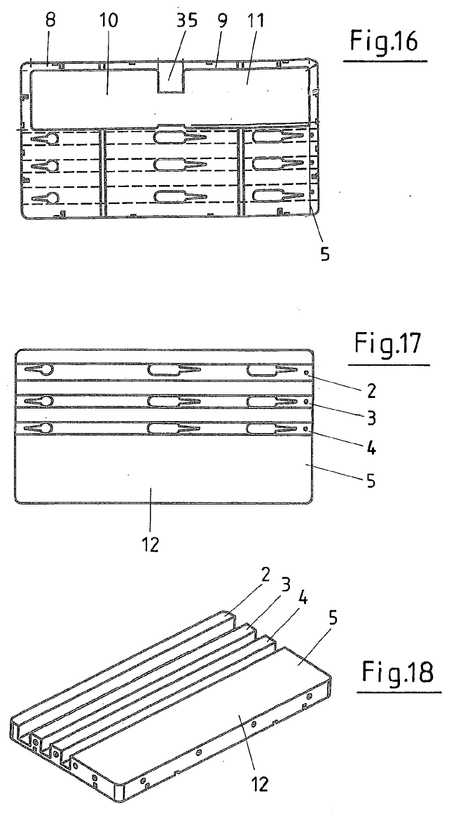

FIG. 16 shows a variant of FIG. 4,

FIG. 17 shows a variant of FIG. 5,

FIG. 18 shows a variant of FIG. 6,

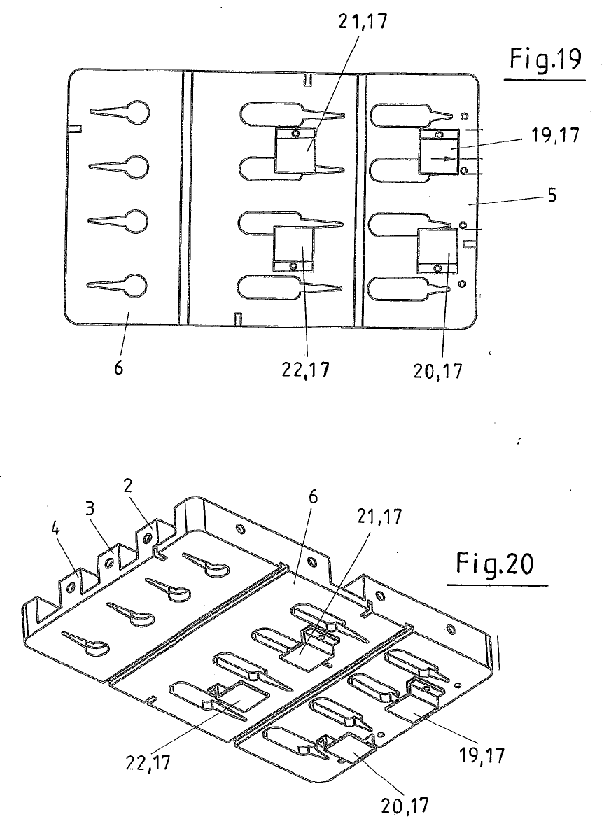

FIG. 19 shows a platform with clamps as fasteners seen from below,

FIG. 20 shows a platform with clamps as fasteners in perspective,

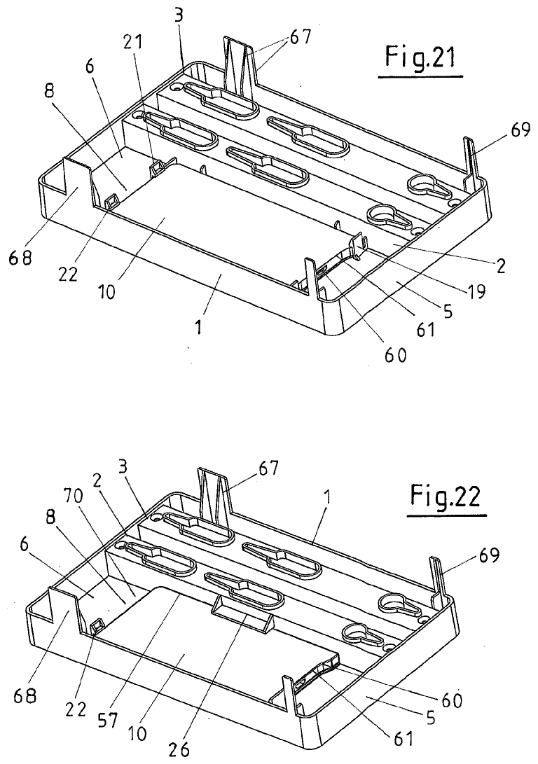

FIG. 21 shows a variant of FIG. 3,

FIG. 22 shows a variant of FIG. 21,

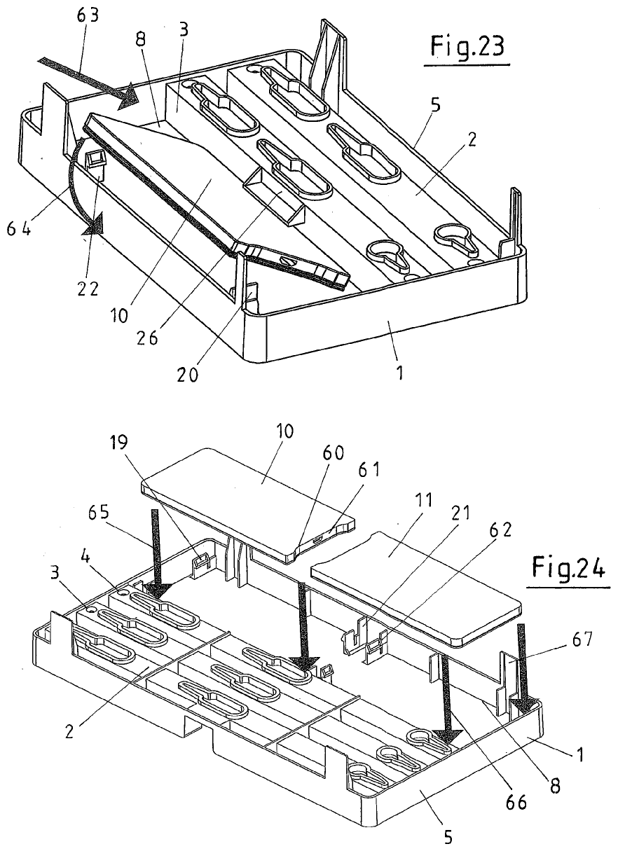

FIG. 23 shows the insertion of a charger into the platform,

FIG. 24 shows a variant of FIG. 23 with two chargers

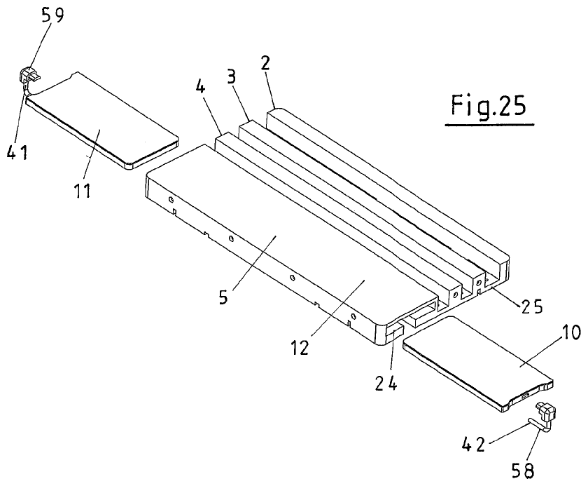

FIG. 25 shows a platform before chargers are inserted

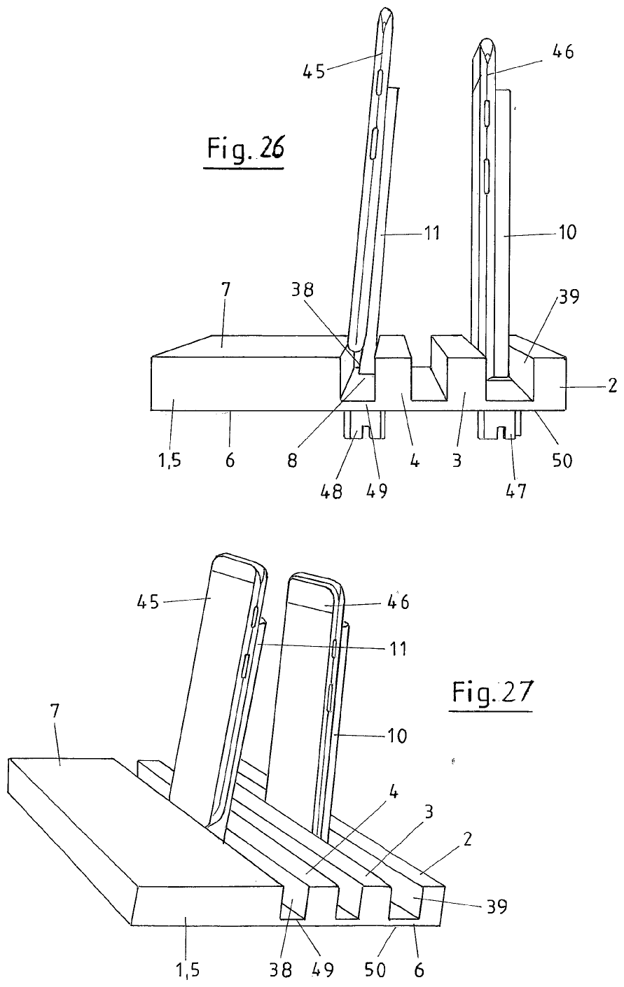

FIG. 26 shows a platform with chargers and Smartphones from the side,

FIG. 27 shows the representation in accordance with FIG. 21 in perspective,

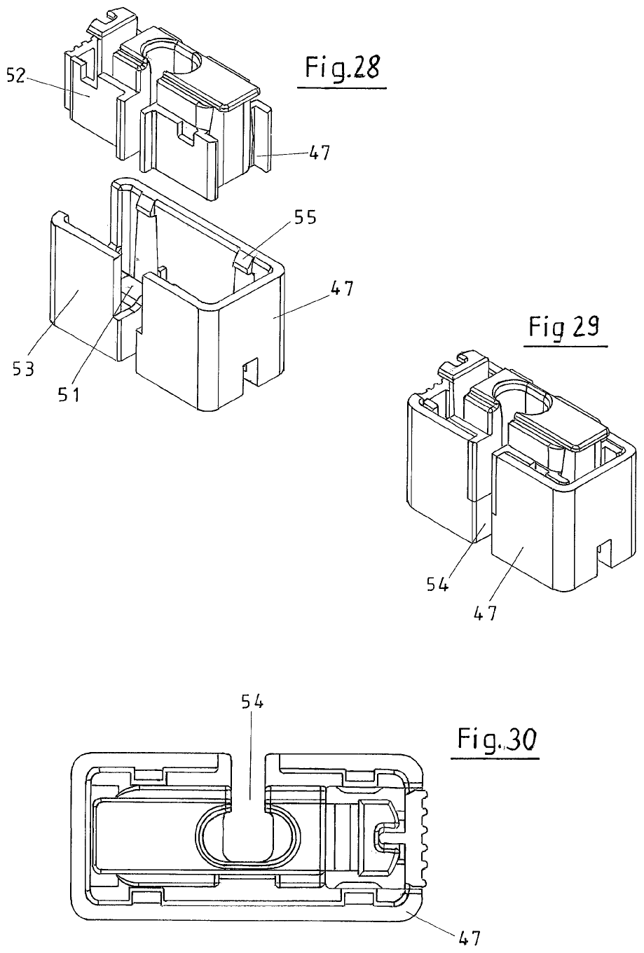

FIG. 28 shows the two housing parts of an adapter,

FIG. 29 shows an assembled adapter,

FIG. 30 shows the adapter from the top,

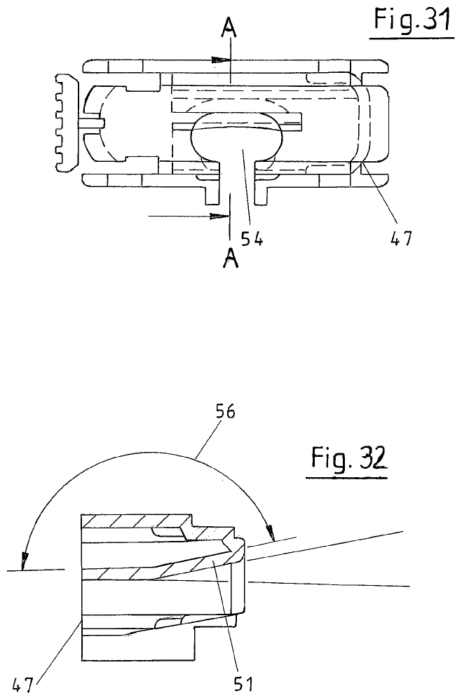

FIG. 31 shows a cross-section through the housing,

FIG. 32 shows a representation in accordance with A-A as in FIG. 26,

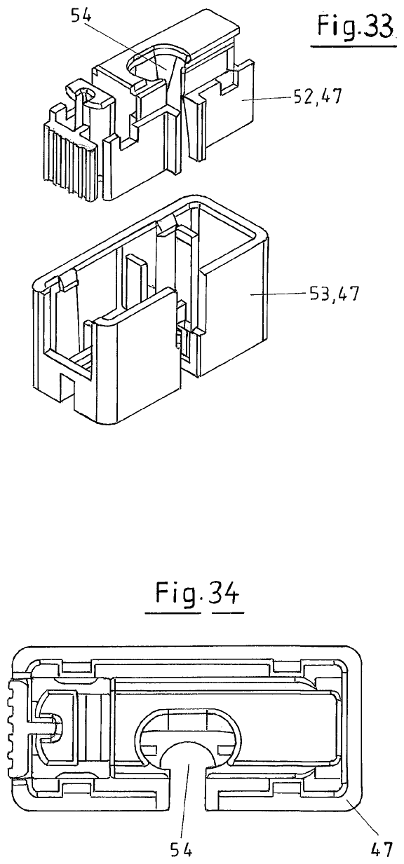

FIG. 33 shows a variant of FIG. 23 and

FIG. 34 shows a variant of FIG. 25.

FIG. 1 shows a platform 5 from its upper side 7 as an essential component of a charging station 1 for telecommunications devices, tablet computers, small electronic devices such as watches etc., not shown here, which can be flexibly inserted between the webs 2-4 into the grooves or recesses 38-40 according to their actual function and at the same time can be recharged. In addition to the webs 2-4, the platform 5 has an inner housing 12 that serves to accommodate one or more chargers that are not visible here. At the end face 25 of the platform 5 is an opening 24 into which the flat chargers can be inserted or slid. Number 34 designates a magnet that serves for connection or adjustment with the housing to complete the charging station, if the platform 5 is inserted into the housing for use for the intended purpose.

FIG. 2 shows such an (outer) housing 30 as the second crucial component of a charging station 1. The magnet 31 in the wall 36 of the housing 30, into which the platform is inserted for use for the intended purpose, corresponds with the magnet 34 of the platform 5 according to FIG. 1. For this purpose, the housing 30 has a circumferential collar 37, so that on the one hand the platform 5 remains easily accessible and on the other hand there is sufficient space underneath for the accommodation of cables, plugs etc.

FIG. 3 illustrates the various functions of a platform 5, viewed from the underside 6 of the same. Two different types of charger 10, 11 are located on this underside 6 of platform 5. Namely a charger 10, which is inserted into a receptacle 8 or recess 15 on the underside 6 of the platform 5, and for illustrative purposes in addition a charger 11, which is fixed in the area of its four corners by means of clamps 19-22. Both chargers 10, 11 are arranged in the direction of their longitudinal axes 13, 14 seen parallel to webs 2-4 in the platform 5. Two of the openings for the feed-through of cables are shown as examples with the reference numbers 32 and 33.

FIGS. 4, 5 and 6 now show a platform 5 from the underside 6, from the top and in perspective. As an example, again, an opening for the feed through of cables is shown with the reference number 32. In receptacle 8 there is a charger 10, more precisely in the inner housing 12 next to the webs 2, 3. This means that FIGS. 4, 5 and 6 show a variant of the invention for exactly one charger 10 with exactly one receptacle 8.

FIGS. 7, 8 and 9 each show a platform 5 for two chargers 10 and 11 in this case, positioned in series in receptacles 8 and 9 on the underside 7 of the platform 5. The chargers 10 and 11, which can be inserted from below into the platform 5 or inserted into it from the outside, are held by fasteners 17 in the form of brackets 18, 23 or metal bands and secured against slipping out, especially since the chargers 10, 11 are housed on the underside 7 of platform 5. FIG. 8 shows the top side 6 of platform 5 with the two chargers 10 and 11. This is also illustrated again in FIG. 9, with the corresponding receptacles 8, 9 for the two chargers 10, 11, whose longitudinal axes 13, 14 are aligned; in this embodiment of the invention the chargers 10, 11 are arranged in series.

Chargers 10, 11 and receptacles 8, 9 in the form of recesses 15, 16 in the inner housing 12 are positioned in parallel in FIGS. 10-12. In this variant of the invention, the webs 2-4 do not pass through the complete length of platform 5, but end approximately after ⅔ of the length of the inner housing 12, where this is attached for receiving the chargers 10, 11.

Chargers 10, 11 are also positioned in parallel in receptacles 8, 9 in accordance with FIGS. 13-15. Webs 2-4 etc. are dimensioned in such a way that the inner housing 12 remains for holding the chargers 10, 11.

The same applies to the variation according to FIGS. 16-18, whereby in this variant receptacles 8, 9 on the underside 6 are again arranged in series, and at the same time next to the inner housing. Number 35 shows a spacer that, where necessary, may also hold chargers 10, 11, not shown here, in their position.

Finally, FIGS. 19 and 20 show the variant of the invention with four clamps 19-22 in the sense of a fastening 17. The four clamps on the underside 6 of platform 5 are located approximately in the area of the four corners of the chargers, which are not shown in FIGS. 19 and 20 for illustrative reasons. The chargers are inserted into these clamps 19-22 in a longitudinal direction, and are then also permanently securely arranged in spite of being attached on the underside 6 of platform 5.

FIG. 21 shows a platform 5 with webs 2, 3 and the inserted charger 10, held by clamps 19, 21, 22 on the respective front sides of the charger 10. The latter has on its front 61 an arc-shaped, inward-aligned recess 60 for better handling when inserting and removing the charger 1 from the platform 5. This also includes feet/spacer elements 68, 69 etc. for connection with a lid or a base plate.

FIG. 22 then shows another type of securing clamp with the visible clamp 22 for the front side 70 and an unseen clamp on the opposite front side 61. In addition, on the longitudinal side 57 of the receptacle 8 for the charger there is a large clamp 26 for fixing the charger 10 in its position on, under, or in the platform 5.

As illustrated by arrows 63, 64, the charger 10 is inserted into the receptacle on the charger side 8, whereby the clamps 26, 22, 20 etc. are employed by fixing and holding the charger 10 in its position at multiple points.

FIG. 24 then shows a variant of the invention with two consecutively positioned chargers 10 and 11. Symbolised by the arrows 65, 66 etc. the chargers 10, 11 with their arc-shaped front sides are inserted turned to each other in the receptacle 8. Terminals 19, 21 etc. secure the two chargers 10, 11.

For this purpose FIG. 25 shows in a supplementary variant of FIG. 1 for instance platform 5 with the webs 2, 3, 4 and the inner housing 12 or more specifically platform 5 with the opening 24 at the face 25 for inserting and removing the charger 1 or on the opposite side for the charger 11.

Reference numbers 58, 59 show connectors and numbers 41, 42 cables, in this case micro USB cables 41, 42. Cable 41, 42 is guided down with the connector 58, 59 directly at 90 degrees. As a result, cable 41, 42 itself no longer has to be bent. It also saves space, because normally the cable must be guided in the appropriate direction. In addition, cable 41, 42 is protected as it is not bent in a direction.

FIG. 26 shows two smartphones 45, 46 inserted in platform 5 of charging station 1, which lean against chargers 10, 11 in the form of a so-called wireless charger, so that the battery of the smartphone is charged. As FIG. 26 illustrates, platform 6 is supported on adapters 47, 48 underneath the receptacles 8, 9 between webs 2, 3 and 4. FIG. 26 shows how, thanks to the non-detectable inclination on the upper side of the adapters 47, 48, the inclination of the devices 45, 46 and their leaning on the chargers 10, 11 is determined. Two different adapter types are conceivable that can be docked on the charging station 1. A first adapter 48 on the right in FIG. 26 has a vertical indentation, so the charger can be attached 10 vertically, in this representation the rear device 10. This gives smartphone 46 and charger 10 space in this groove 39 between the webs 2, 3. The other adapter, here the left adapter 48, can only be inserted into groove 38 because of the inclined upper or inside surface of adapter 47. For this purpose, adapter 48 has an inclination, for the purpose of charging smartphone 45 can simply be leaned against charger 11.

This is illustrated by FIG. 27 in a perspective view of platform 5 with the webs 2, 3, 4 and smartphones 45, 46 as well as the chargers 10, 11 in the intervening grooves 38, 39.

FIG. 28 shows an adapter 47 comprising the upper housing part 52 and the lower housing part 53. For this purpose, catches with the reference number 55 serve as an example. In addition, FIG. 23 reveals a view of the inner workings of the lower housing part 53 in such a way that the area 51 can be seen, which is inclined. Thus, this inclined surface 51 predefines the inclination of smartphones or the wireless charger in the grooves between the webs of the platform.

Such an adapter 47 is shown put together in FIG. 29. Number 54 has an indentation 54 for a possible cable connection between the top and bottom of the platform.

This is also illustrated in FIG. 30 in the form of adapter 47.

The representation in FIG. 31 then shows in particular what is meant by the section in FIG. 32, namely the inclined surface 51, expressed also by the obtuse angle, indicated with the reference number 56.

FIG. 33 then shows a variant of FIG. 23 with the two housing parts 52 and 53 and the indentation 54 for passing a cable through.

A corresponding representation can then also be found in FIG. 34.

1. Charging station (1) for telecommunications equipment, tablet computers, small electronic devices such as watches, etc., with a platform (5) having several webs (2-4) parallel to each other, below which supply cables and connectors can be placed to connect to the appropriate charger, wherein at least one receptacle (8, 9) for a charger (10, 11) is provided on the underside (6) of the platform (5).

2. Charging station in accordance with claim 1, wherein the longitudinal axis (13, 14) of the receptacle (8, 9) is arranged parallel to the webs (2-4).

3. Charging station in accordance with claim 1, wherein at least two receptacles (8, 9) are arranged in parallel on the underside (6) of the platform (5).

4. Charging station in accordance with claim 1, wherein at least two receptacles (8, 9) are arranged in series on the underside (6) of the platform (5).

5. Charging station in accordance with claim 1, wherein a recess (15, 16) on the underside (6) of the platform (5) serves as receptacle (8, 9) for the charger (10, 11).

6. Charging station in accordance with claim 5, wherein the platform (5) on the face (24) has an opening (25) for inserting the charger (10, 11) into the recess (15, 16).

7. Charging station in accordance with claim 5, wherein the recess (15, 16) on the underside (6) of the platform (5) has at least one fixture (17) for a charger (10, 11).

8. Charging station in accordance with claim 7, wherein at least one, preferably two clamps (23, 24) serve as fixture (17) for the charger (10, 11).

9. Charging station in accordance with claim 7, wherein several, preferably four clamps (19-22) serve as fixture (17) for the charger (10, 11).

10. Charging station in accordance with claim 1, wherein the platform (5) has in each case a recess (15) and several clamps (19-22) for chargers (10,11).

11. Charging station in accordance with claim 1, wherein adapters (47, 48) are positioned on the underside (49, 50) of the platform (5).

12. Charging station in accordance with claim 11, wherein the adapters (47, 48) partly pass through the receptacles (8, 9) for the devices (45, 46) on the underside (49, 50) and in this way serve as supports for the devices (45, 46).

13. Charging station in accordance with claim 11, wherein an inclined surface (51) is integrated in the adapter (47, 48).

14. Charging station in accordance with claim 11, wherein the adapter (47, 48) has a top housing part (52) and a bottom housing part (53), whereby both housing parts (52, 53) are connected to one another.
